(19) United States
(12) Patent Application Publication
(10) Pub. No.: US 2024/0356925 A1
(43) Pub. Date: Oct. 24, 2024

(54) SYSTEM AND METHOD FOR USE OF GRAPH NEURAL NETWORKS IN IDENTITY MANAGEMENT ARTIFICIAL INTELLIGENCE SYSTEMS

(71) Applicant: SailPoint Technologies, Inc., Wilmington, DE (US)

(72) Inventors: Mohamed M. Badawy, Round Rock, TX (US); Jostine Fei Ho, Austin, TX (US); Sana Amin Rajani, Cincinnati, OH (US); Quoc Co Tran, Houston, TX (US)

(21) Appl. No.: 18/303,425

(22) Filed: Apr. 19, 2023

(51) Int. Cl. H04L 9/40; H04L 41/16

(52) U.S. Cl. CPC H04L 63/102; H04L 41/16

(57) ABSTRACT

Systems and methods for embodiments of a graph based artificial intelligence systems for identity management are disclosed. Embodiments of the identity management systems disclosed herein may utilize graph neural networks for the implementation of identity management components. An identity management system may create an identity graph from identity management data. An embedding for the identity graph representing the identity management data for the enterprise may be generated and that embedding used as the basis for training a graph neural network for an identity management component. Once a graph neural network is trained for a particular identity management component, the identity management component can apply the associated trained graph neural network during operation of that component in the identity management system.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates generally to computer security. In particular, this disclosure relates to the application of artificial intelligence to identity management in a distributed and networked computing environment. Even more specifically, this disclosure relates to enhancing computer security in a distributed networked computing environment through the use of platforms for accurate decision making or recommendations in an identity management context, including the use of graph neural networks to analyze graphs of identity management artifacts and the determination, prioritization or evaluation of identity management data or recommendations based on such graph analysis.

### BACKGROUND

Acts of fraud, data tampering, privacy breaches, theft of intellectual property, and exposure of trade secrets have become front page news in today's business world. The security access risk posed by insiders—persons who are granted access to information assets—is growing in magnitude, with the power to damage brand reputation, lower profits, and erode market capitalization.

Identity Management (IM), also known as Identity and Access Management (IAM) or Identity Governance (IG), is, the field of computer security concerned with the enablement and enforcement of policies and measures which allow and ensure that the right individuals access the right resources at the right times and for the right reasons. It addresses the need to ensure appropriate access to resources across increasingly heterogeneous technology environments and to meet increasingly rigorous compliance requirements. Escalating security and privacy concerns are driving governance, access risk management, and compliance to the forefront of identity management. To effectively meet the requirements and desires imposed upon enterprises for identity management, these enterprises may be required to prove that they have strong and consistent controls over who has access to critical applications and data. And, in response to regulatory requirements and the growing security access risk, most enterprises have implemented some form of user access or identity governance.

Yet many companies still struggle with how to focus compliance efforts to address actual risk in what usually is a complex, distributed networked computing environment. Decisions about which access entitlements are desirable to grant a particular user are typically based on the roles that the user plays within the organization. In large organizations, granting and maintaining user access entitlements is a difficult and complex process, involving decisions regarding whether to grant entitlements to thousands of users and hundreds of different applications and databases. This complexity can be exacerbated by high employee turnover, reorganizations, and reconfigurations of the various accessible systems and resources.

Organizations that are unable to focus their identity compliance efforts on areas of greatest access risk can waste time, labor, and other resources applying compliance monitoring and controls across the board to all users and all applications. Furthermore, with no means to establish a baseline measurement of identity compliance, organizations have no way to quantify improvements over time and demonstrate that their identity controls are working and effectively reducing access risk.

Information Technology (IT) personnel of large organizations often feel that their greatest security risks stemmed from “insider threats,” as opposed to external attacks. The access risks posed by insiders range from careless negligence to more serious cases of financial fraud, corporate espionage, or malicious sabotage of systems and data. Organizations that fail to proactively manage user access can face regulatory fines, litigation penalties, public relations fees, loss of customer trust, and ultimately lost revenue and lower stock valuation. To minimize the security risk posed by insiders (and outsiders), business entities and institutions alike often establish access or other governance policies that eliminate or at least reduce such access risks and implement proactive oversight and management of user access entitlements to ensure compliance with defined policies and other good practices.

One of the main goals of identity management, then, is to help users identify and mitigate risks. To aid in the identification and mitigation of risk, identity management systems may produce a wide variety of signals regarding such identity management and identity management data, including identity management data, recommendations, actions, visualizations, or other signals for users involved in such identity management. The sheer volume of these types of signals can be overwhelming for users, leaving them confused about which of these signals are actually important or significant. The user therefore cannot prioritize such signals and is typically has no idea which of the recommended actions would achieve desired progress toward minimization of security risk or more generally increasing the overall “health” of their identity management ecosystem.

Accordingly, it is desirable for identity management solutions to offer tools to assist in the assessment of identity management signals to produce relevant analysis, predictions, or recommendations for a user to assist in ameliorating identity governance issues and proactively address potential issues that could negatively impact security across an enterprise.

### SUMMARY

To illustrate certain aspect in more detail, as may be understood, an identity management system may have many different components that generate different outputs, including data, recommendations, predictions, actions, alerts, actions, notifications, etc. (collectively referred to as signals) regarding identity management data associated with an enterprise. These signals may include data such as data generated from the modeling or analysis of identity management data of an enterprise using, for example identity graphs representing identity management data of that enterprise. Thus, the components that may generate these signals may include peer group analysis component, role, identity or entitlement mining or validation components, access modeling components, risk analysis components, access recommender components, visualization components, or outlier and anomaly detection components, among others. Accordingly, these signals may include identity management data, visualizations, recommendations, predictions, or actions or other types of signals For example, these signals may include static or dynamic analysis of management, activity or usage data, role validation, health scores for identity management structures, data or recommendations on certification requests and approval or denial of such requests, among other data.

A wide variety of components are employed in these types of identity management systems to generate these signals. The implementation and design of such components may be heavily tailored to the functionality of that particular component. Thus, there may be little universality between these components, resulting in the complex design and deployment of those various components in identity management systems. In particular, the algorithms used for each of these types of components may require specific analysis of the underlying identity graph representing the identity management data and a tailored analysis of these identity graphs. These components may thus require custom implementation, development, maintenance, etc.

Moreover, there may be problems related to certain of the individual algorithms applied by these components. In some cases, these problems may be attributable to the use of network identity graphs as the basic data structure for the representation of identity management data and the application of certain types of algorithms with respect to those identity management graphs. To illustrate one specific example, in the case of clustering of identity graphs to ascertain certain signals, particular algorithms may be applied, such as the Louvain algorithm for community detection. The Louvain algorithms is not without its problems. The Louvain algorithm often fails to identify certain clusters (e.g., roles) on a granular level, resulting in less useful clusters (e.g., roles) being discovered, and highly anemic identity coverage. Exacerbating this problem, is the fact that the larger the identity graph, the lower resolution of the clusters (e.g., roles) produced by application of the Louvain algorithm. This is a well-known phenomenon among many modularity optimization algorithms in community detection, and as identity graphs may be quite large in certain contexts these problems may be quite prominent.

The use of the Louvain algorithm in certain identity management components (and its associated problems) is thus a microcosm of a larger problem. Namely, that current frameworks and algorithms for analysis of identity management data represented by identity graphs are insufficient and require a large amount of customization for different types of functionality in these varied components.

What is desired therefore, is a more general framework for the architecture and implementation of identity management components based on identity graphs representing identity management data.

To that end, among others, embodiments of identity management systems and methods for their operation may utilize graph neural networks for the implementation of identity management components. In particular, according to embodiments an identity management system may create an identity graph from identity management data obtained from an enterprise. The identity management system may employ a framework for forming identity management components whereby an embedding for the identity graph representing the identity management data for the enterprise may be generated at a particular point in time (e.g., based on the identity graph representing the enterprise's identity management data) and that embedding used as the basis for training a graph neural network for one or more associated identity management components. Such a graph neural network may thus encompass an optimizable transformation on attributes of the network identity graph (e.g., nodes, edges, global-context, etc.) that preserves graph symmetries (e.g., permutation invariances) such that the identity graph is progressively transformed into embeddings without significantly altering the structure (e.g., connectivity) of the identity graph.

Specifically, for a particular identity management component with an associated functionality, an embedding of the identity graph may be used to train a graph neural network based on an associated loss function adapted for the functionality of that component. The loss function for a particular identity management component may be designed based on, or otherwise adapted for, the type of learning of task embodied by that identity management component.

These tasks for an identity management component may, for example, be related to node-level tasks, edge-level tasks, or graph-level tasks. Node-level tasks focus on nodes of the underlying graph (e.g., node classification, node regression, node clustering, etc.). Edge-level tasks such as edge classification or prediction may entail applying the resulting graph neural network to classifying edge types or predicting whether an edge will or should exist between two given nodes. Graph-level tasks include graph classification, graph regression, and graph-matching. Thus, in the context of identity management components these identity management components may be adapted to implement clustering, such as components adapted for peer grouping of nodes of the identity graph for role mining and access modeling, classifying outliers, preforming role mining on an identity graph; providing recommendations such as access request recommenders; visualizing of an underlying identity graph; or classification of nodes in the graph (e.g., imputing missing data, outlier entities, etc.), among other tasks.

Once a graph neural network is trained for a particular identity management component (e.g., based on the embeddings of the identity graph and the loss function adapted for the task of that particular identity management component), the identity management component can apply the associated trained graph neural network during operation of that component in the identity management system.

In this manner, embodiments may utilize such a framework for forming a set of identity management components for an identity management systems whereby an embedding for an identity graph representing identity management data for an enterprise may be generated at a particular point in time (e.g., based on an identity graph representing the enterprise's identity management data at a point in time) and that same embedding used as the basis for training a graph neural network for each of the set of components based on an associated loss function adapted for the functionality of that component.

Embodiments provide numerous advantages over previously available systems and methods for measuring access risk. As certain embodiments are based on a graph representation of identity management data, the graph structure may serve as a physical model of the data, allowing more intuitive access to the data (e.g., via graph database querying, or via graph visualization techniques). This ability may yield deeper and more relevant insights for users of identity management systems. Such abilities are also an outgrowth of the accuracy of the results produced by embodiments as disclosed.

Accordingly, embodiments may provide significant advantages in that a unified approach to implementing different functionality for identity management components may be provided without having to utilize individualized algorithms for each type of functionality implemented by those components. Moreover, using a graph neural network framework for identity management components allows these components to be implemented in an efficient manner based on the same underlying representation of identity management data (e.g., an identity graph). The use of graph neural networks in these approaches may also provide a highly scalable method for implementing such identity management components, as graph neural networks may be efficiently implemented utilizing specialized processors such graphics processing units (GPUs) or the like. Such a graph neural network framework may thus be easily and efficiently scaled, resulting in faster and simpler implementation and deployment of resulting identity management components generated using such a framework. As an added advantage, graph neural networks may have a smaller memory utilization than certain other models since only information about connections between nodes may need to be stored. As such, these embodiments of identity management systems may allow an accurate and efficient approach to determinations of identity management health in identity governance and remedial or other actions that may be taken to improve the health of the state of an enterprises identity management. Thus, embodiments may improve the performance and responsiveness of identity management systems that utilize such embodiments of identity graphs and graph neural network approaches by reducing the computation time and processor cycles required (e.g., and thus improving processing speed) and simultaneously reducing memory usage or other memory requirements.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of a distributed networked computer environment including one embodiment of an identity management system.

FIG. 2 is a flow diagram of one embodiment of a method for generation of an identity graph.

FIG. 3 is a visual representation of one example of an identity graph.

FIG. 4 is a hybrid diagram depicting the training and use of graph neural networks for identity management components.

FIG. 5 is a depiction of one example of a graph visualization.

FIG. 6 is diagram of the training of a graph neural network for a clustering identity management component.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into more details regarding the specific embodiments disclosed herein, some context may be helpful. In response to regulatory requirements and security access risks and concerns, most enterprises have implemented some form of computer security or access controls. To assist in implementing security measures and access controls in an enterprise environment, many of these enterprises have implemented Identity Management in association with their distributed networked computer environments. Identity Management solutions allow the definition of a function or an entity associated with an enterprise. An identity may thus represent almost physical or virtual entity, place, person or other item that an enterprise would like to define. Identities can therefore represent, for example, functions or capacities (e.g., manager, engineer, team leader, etc.), title (e.g., Chief Technology Officer), groups (development, testing, accounting, etc.), processes (e.g., nightly back-up process), physical locations (e.g., cafeteria, conference room), individual users or humans (e.g., John Locke) or almost any other physical or virtual entity, place, person or other item. Each of these identities may therefore be assigned zero or more entitlements with respect to the distributed networked computer environments. An entitlement may be the ability to perform or access a function within the distributed networked computer environments, including, for example, accessing computing systems, applications, file systems, particular data or data items, networks, subnetworks or network locations, etc.

To facilitate the assignment of these entitlements, enterprises may also be provided with the ability to define roles within the context of their Identity Management solution. A role within the context of Identity Management may be a collection of entitlements. These roles may be assigned a name or identifiers (e.g., manager, engineer, team leader) by an enterprise that designate the type of user or identity that should be assigned such a role. By assigning a role to an identity in the Identity Management context, the identity may be assigned the corresponding collection of entitlements associated with the assigned role. Accordingly, by defining these roles enterprises may define a “gold standard” of what they desire their identity governance to look like.

Thus, by managing the identities, entitlements, roles or other identity management structures within the enterprise computing environment, the assignment of entitlements and the proliferation of these roles or entitlements may be controlled. However, escalating security and privacy concerns are driving governance, access risk management, and compliance to the forefront of Identity Management. Yet many companies still struggle with how to focus compliance efforts to address actual risk in what usually is a complex, distributed networked computing environment. Decisions about which access roles or entitlements are desirable to grant a particular user are typically based on the business roles that the user plays within the organization. In large organizations, granting and maintaining roles and user access entitlements is a difficult and complex process, involving decisions regarding whether to grant roles or entitlements to thousands of users and hundreds of different applications and databases. This complexity can be exacerbated by high employee turnover, reorganizations, and reconfigurations of the various accessible systems and resources.

However, to effectively meet the requirements and desires imposed upon enterprises for Identity Management, these enterprises may be required to prove that they have strong and consistent controls over who has access to critical applications and data. Generally then, what is desired are effective system and methods for providing a holistic view and assessment of the overall access model health across an enterprise, and specifically for assessing the health of identity management structures within an enterprise.

To those ends, among others, embodiments of the identity management systems disclosed herein may utilize a network graph approach to improve identity governance, including the assessment of identity management structures (e.g., identities, entitlements, roles, etc.) associated with the identity management data of an enterprise. Embodiments may thus generate a network identity graph that includes nodes for identities, entitlements, roles or other identity management artifacts of an enterprise. Such an identity graph may be, or may include, identity nodes representing identities associated with those enterprises and entitlements shared between those identities, or role nodes representing roles associated with the enterprises. Edges of the graph may represent similarities between the identities or roles (e.g., represented by the nodes). These edges may comprise a similarity weight determined, based on, for example, shared entitlements between the identities or roles or by concurrent identities (e.g., a number of identities that share those roles).

In one embodiment, for example, the graph may be modeled in terms of entitlement (e.g., access) similarities between the identities or roles. A weight may be computed for the access similarity relationship based on the entitlements shared between the two identities or roles and the number of entitlements the roles include. Embodiments of these identity graphs may give high-level of abstractions on the overall access model of an enterprise while accurately reflecting the global identity management structure. As such, these identity graphs may be useful, for example, as a provisioning QA (Quality Assessment) tool indicating overall well-being of an enterprise's role structure, in recommending consolidation of redundant structures, or verifying how new structures may fit in the current access model. Moreover, according to embodiments, various metrics may be determined for assessing the quality or health of the identity management structures of an enterprise based on an identity graph.

In certain cases, the efficacy of embodiments of structure assessment in an identity management system may depend at least partially on the state of the identities, entitlements or roles within a distributed computing enterprise. Accordingly, it may be useful to an understanding of certain embodiments if the analysis and use of roles, entitlements and identities of an enterprise by embodiments of artificial intelligence identity governance systems are discussed in more detail.

With that in mind, it may be understood that good governance practice in the identity space relies on the ‘social’ principle that identities with strongly similar attributes should be assigned similar, if not identical, access entitlements. In the realm of identity governance and administration, this approach allows for a separation of duties and thus makes it feasible to identify, evaluate, and prioritize risks associated with privileged access. As part of a robust identity management system, it is therefore highly desirable to analyze an enterprise's data to identify potential risks. In principle, strictly enforced pre-existing governance policies should ensure that identities with strongly similar access privileges are strongly similar. It would thus be desirable to group or cluster the identities of an enterprise into peer groups such that the identities (or entitlements, roles, etc.) in a peer group are similar with respect to the set of entitlements assigned to the identities of that group (e.g., relative to other identities or other groups). Peer grouping of the identities within an enterprise (or viewing the peer groups of identities) may allow, for example, an auditor or other person performing a compliance analysis or evaluation to quantitatively and qualitatively assess the effectiveness of any applicable pre-existing polices, or lack thereof, and how strictly they are enforced.

However, the data utilized by most identity management systems is not strictly numerical data. Often this data includes identifications of identities (e.g., alphanumeric identifiers for an identity as maintained by an identity management system) and identifications of entitlements or roles associated with those identities (e.g., alphanumeric identifiers for entitlements or roles as maintained by the identity management system). This data may also include data identifying roles (e.g., alphanumeric identifiers or labels for a role as maintained by an identity management solution) and identifications of entitlements associated with those roles (e.g., alphanumeric identifiers for the collection of entitlements associated with those roles). Clustering of this type of categorical data (e.g., for peer grouping of identities) is typically a harder task than clustering data of numerical type. In particular, clustering categorical data is particularly challenging since intuitive, geometric-based, distance measures experienced in real life, e.g., Euclidean distance, by definition, are exclusive to numerical data. A distance measure is a crucial component of any clustering algorithm as it is utilized at the lowest level to determine how similar/dissimilar two data points are.

Accordingly, to ameliorate these issues, among other ends, embodiments of the identity management systems disclosed herein may utilize a identity graph approach to analyzing identity management data distributed networked enterprise computing environment. Specifically, in certain embodiments, data on the identities, roles, and the respective entitlements assigned to each identity or role as utilized in an enterprise computer environment may be obtained by an identity management system. Using the identity management data, then, an identity graph may be constructed, where the nodes of the graph correspond to, and represent, each of the identities, roles, entitlements, or other identity management structures. Each edge (or relationship) of the graph may join two nodes of the graph. A weight (e.g., a similarity weight representing a degree of similarity between the respective nodes) may also be assigned to an edge.

Such an identity graph may be utilized by a number of components of an identity management system to generate different identity management signals, including visualizations, recommendations, predictions, actions, alerts, actions, notifications, etc. regarding identity management data associated with an enterprise. For example, the components that may generate these signals may include peer group analysis component, role, identity or entitlement mining or validation components, access modeling components, risk analysis components, access recommender components, visualization components, or outlier and anomaly detection components, among others. For example, these signals may include static or dynamic analysis of management, activity or usage data, role validation, health scores for identity management structures, data or recommendations on certification requests and approval or denial of such requests, among other data.

Embodiments of identity management systems and methods for their operation may utilize graph neural networks (GNNs) for the implementation of these identity management components. In particular, according to embodiments an identity management system may create an identity graph from identity management data obtained from an enterprise. The identity management system may employ a framework for forming identity management components whereby an embedding for the identity graph representing the identity management data for the enterprise may be generated at a particular point in time (e.g., based on the identity graph representing the enterprise's identity management data) and that embedding used as the basis for training a graph neural network for one or more associated identity management components. Such a graph neural network may thus encompass an optimizable transformation on attributes of the network identity graph (e.g., nodes, edges, global-context, etc.) that preserves graph symmetries (e.g., permutation invariances) such that the identity graph is progressively transformed into embeddings without significantly altering the structure (e.g., connectivity) of the identity graph.

Specifically, for a particular identity management component with an associated functionality, an embedding of the identity graph may be used to train a graph neural network based on an associated loss function adapted for the functionality of that component. The loss function for a particular identity management component may be designed based on, or otherwise adapted for, the type of learning of task embodied by that identity management component.

These tasks for an identity management component may, for example, be related to node-level tasks, edge-level tasks, or graph-level tasks. Node-level tasks focus on nodes of the underlying graph (e.g., node classification, node regression, node clustering, etc.). Edge-level tasks such as edge classification or prediction may entail applying the resulting graph neural network to classifying edge types or predicting whether an edge will or should exist between two given nodes. Graph-level tasks include graph classification, graph regression, and graph-matching. Thus, in the context of identity management components these identity management components may be adapted to implement clustering, such as components adapted for peer grouping of nodes of the identity graph for role mining and access modeling, classifying outliers, preforming role mining on an identity graph; providing recommendations such as access request recommenders; visualizing of an underlying identity graph; or classification of nodes in the graph (e.g., imputing missing data, outlier entities, etc.), among other tasks.

Once a graph neural network is trained for a particular identity management component (e.g., based on the embeddings of the identity graph and the loss function adapted for the task of that particular identity management component), the identity management component can apply the associated trained graph neural network during operation of that component in the identity management system. In this manner, embodiments may utilize such a framework for forming a set of identity management components for an identity management systems whereby an embedding for an identity graph representing identity management data for an enterprise may be generated at a particular point in time (e.g., based on an identity graph representing the enterprise's identity management data at a point in time) and that same embedding used as the basis for training a graph neural network for each of the set of components based on an associated loss function adapted for the functionality of that component.

Embodiments may therefore employ GNNs for different types of components within an identity management system. One particular type of component with which such GNNs may be utilized are recommendation components. Specifically, embodiments may utilize the framework of GNN for recommendation system for access or certification request recommendations in the identity governance space such that recommendations may be produced by the component based on a GNN generated on the basis of an identity graph. In these types of embodiments, the GNN is used to generate embeddings for nodes and edges of the identity graph. The GNN model will extract this information by propagating through a bipartite graph of identities and entitlements, scanning the featured of the nodes and edges, and performing a message passing paradigm to produce embeddings for the nodes and edges. Then, these embeddings will be used either by passing them through a neural network to produce a score to determine a recommendation (e.g., whether or not an entitlement should be granted to, or revoked from, a particular identity).

As the nature of embodiments of a identity graph as discussed herein may be bipartite, and thus a natural fit for the required or desired structures for GNN recommendation systems, several aspects may be utilized or modified to better conform GNNs to, or utilize GNNs in, the context of identity governance. For example, one area pertains to a loss function that may be utilized with GNNs for such components. According to embodiments, the rewarding mechanism to calculate the loss function may be tailored to identity governance. For example, in an access or certification request recommendation component, a model may be adapted to focus on the accuracy of recommending revocation or grant of a correct entitlement, while recommenders utilized in other contexts (such as media, etc.) may be optimized to maximize a hit rate (e.g., number of predicted like items over the liked items in ground truth data). Hence, an adaptation of loss functions may be needed when applying particular GNN solutions for an identity governance recommendation component.

To illustrate in more detail, a usual loss function for certain GNN recommendation systems may be BPR (Bayesian Personalized Ranking), which is optimized for rewarding the correct ranking of preference by the users. In contrast, embodiments may utilize a binary cross entropy as a loss function for a classification task of granting/not granting or revoking an entitlement (e.g., a 1/-1/0 label respectively). The use of such a loss function may be desired because identity governance systems may not have access to, or utilize, a ranking need/score for access or certification requests. The nature of such access or certification requests are oriented more toward binary operation than a continuous stream of preference ranking.

With respect to the model structure, identity governance may be quite a bit more feature rich than a typical context for the application of GNNs. These features may stem, for example, from the nodes and edges of the identity graph on which GNNs in the identity management context may be based. Not all GNN architectures for recommendation systems may accept node and edge features for the generation of embeddings for recommendations. Accordingly, the need to accommodate such features may help determine the choice of attention based GNNs for use in particular embodiments. On the other hand, most benchmarking graph datasets don't have the same type of node edge feature like Jaccard similarity for identities as may be utilized in embodiments. This provides another chance to customize the inputs and the way the GNN receive the inputs from the graph.

Embodiments may also be tailored to prepare data in a particular manner for use in such GNN recommendation components. As opposed to the majority of machine learning models, GNNs take graphs as inputs. Accordingly, the representation of identities and entitlements nodes for a training, validation and testing split may be much more important than in machine learning models with tabular inputs. Accordingly, embodiments may utilize a data splitting method to ensure the equal representation of identity or entitlement distribution. Moreover, the existence of node or edge features of a graph may be utilized to enrich a dataset with more computed features for the edge between identity and entitlement.

Embodiments may thus provide a number of advantages including allowing more accurate identity management data and more intuitive access to the data (e.g., via graph visualization techniques), which may, in turn, yield deeper and more relevant insights for users of identity management systems. Moreover, embodiments as disclosed may offer the technological improvement of reducing the computational burden and memory requirements of systems implementing these embodiments through the improved data structures and the graph processing and analysis implemented by such embodiments. Accordingly, embodiments may improve the performance and responsiveness of identity management systems that utilize such embodiments. Moreover, the graph format used by certain embodiments, allows the translation of domain and enterprise specific concepts, phenomena, and issues into tangible, quantifiable, and verifiable hypotheses which may be examined or validate with graph neural networks. Accordingly, embodiments may be especially useful in assessing risk and in compliance with security policies or the like.

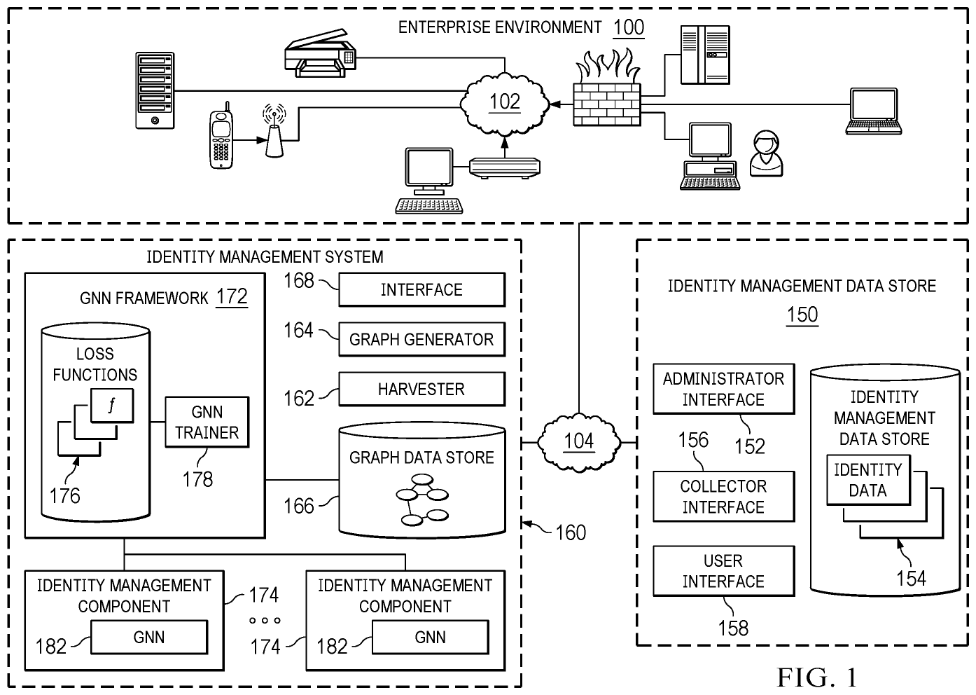

Turning first to FIG. 1, then, a distributed networked computer environment including one embodiment of an identity management system is depicted. Here, the networked computer environment may include an enterprise computing environment 100. Enterprise environment 100 includes a number of computing devices or applications that may be coupled over a computer network 102 or combination of computer networks, such as the Internet, an intranet, an internet, a Wide Area Network (WAN), a Local Area Network (LAN), a cellular network, a wireless or wired network, or another type of network. Enterprise environment 100 may thus include a number of resources, various resource groups and users associated with an enterprise (for purposes of this disclosure any for profit or non-profit entity or organization). Users may have various roles, job functions, responsibilities, etc. to perform within various processes or tasks associated with enterprise environment 100. Users can include employees, supervisors, managers, IT personnel, vendors, suppliers, customers, robotic or application based users, etc. associated with enterprise 100.

Users may access resources of the enterprise environment 100 to perform functions associated with their jobs, obtain information about enterprise 100 and its products, services, and resources, enter or manipulate information regarding the same, monitor activity in enterprise 100, order supplies and services for enterprise 100, manage inventory, generate financial analyses and reports, or generally to perform any task, activity or process related to the enterprise 100. Thus, to accomplish their responsibilities, users may have entitlements to access resources of the enterprise environment 100. These entitlements may give rise to risk of negligent or malicious use of resources.

Specifically, to accomplish different functions, different users may have differing access entitlements to differing resources. Some access entitlements may allow particular users to obtain, enter, manipulate, etc. information in resources which may be relatively innocuous. Some access entitlements may allow particular users to manipulate information in resources of the enterprise 100 which might be relatively sensitive. Some sensitive information can include human resource files, financial records, marketing plans, intellectual property files, etc. Access to sensitive information can allow negligent or malicious activities to harm the enterprise itself. Access risks can thus result from a user having entitlements with which the user can access resources that the particular user should not have access to; or for other reasons. Access risks can also arise from roles in enterprise environment 100 which may shift, change, evolve, etc. leaving entitlements non optimally distributed among various users.

To assist in managing the entitlements assigned to various users and more generally in managing and assessing access risks in enterprise environment 100, an identity management system 150 may be employed. Such an identity management system 150 may allow an administrative or other type of user to define one or more identities, one or more entitlements, or one or more roles, and associate defined identities with entitlements using, for example, an administrator interface 152. The assignment may occur, for example, by directly assigning an entitlement to an identity, or by assigning a role to an identity whereby the collection of entitlements comprising the role are thus associated with the identity. Examples of such identity management systems are Sailpoint's IdentityIQ and IdentityNow products. Note here, that while the identity management system 150 has been depicted in the diagram as separate and distinct from the enterprise environment 100 and coupled to enterprise environment 100 over a computer network 104 (which may the same as, or different than, network 102), it will be realized that such an identity management system 150 may be deployed as part of the enterprise environment 100, remotely from the enterprise environment, as a cloud based application or set of services, or in another configuration.

An identity may thus be almost physical or virtual thing, place, person or other item that an enterprise would like to define. For example, an identity may be a capacity, groups, processes, physical locations, individual users or humans or almost any other physical or virtual entity, place, person or other item. An entitlement may be an item (e.g., token) that upon granting to a user will allow the user to acquire a certain account or privileged access level that enables the user to perform a certain function within the distributed networked enterprise computer environment 100. Thought of another way, an entitlement may be a specific permission granted within a computer system, such as access to a particular building (based on a user's key badge), access to files and folders, or access to certain parts of websites. Entitlements may also define the actions a user can take against the items they have access to, including, for example, accessing computing systems, applications, file systems, particular data or data items, networks, subnetworks or network locations, etc. Each of these identities may therefore be assigned zero or more entitlements with respect to the distributed networked computer environments.

To facilitate the assignment of these entitlements, enterprises may also be provided with the ability to define roles through the identity management system 150. A role within the context of the identity management system 150 may be a collection of entitlements. These roles may be assigned a name or identifiers (e.g., manager, engineer_level_2, team leader) by an enterprise that designate the type of user or identity that should be assigned such a role. By assigning a role to an identity using the identity management system 150, the identity may be assigned the corresponding collection of entitlements associated with the assigned role.

The identity management system 150 may thus store identity management data 154. The identity management data 154 stored may include a set of entries, each entry corresponding to and including an identity (e.g., alphanumerical identifiers for identities) as defined and managed by the identity management system, a list or vector of entitlements or roles assigned to that identity by the identity management system, and a time stamp at which the identity management data was collected from the identity management system. Other data could also be associated with each identity, including data that may be provided from other systems such as a title, location or department associated with the identity. The set of entries may also include entries corresponding to roles, where each entry for a role may include the role identifier (e.g., alphanumerical identifier or name for the role) and a list or vector of the entitlements associated with each role. Other data could also be associated with each role, such as a title, location or department associated with the role.

Collectors 156 of the identity management system 150 may thus request or otherwise obtain data from various touchpoint systems within enterprise environment 100. These touchpoint systems may include, for example Active Directory systems, Java Database Connectors within the enterprise 100, Microsoft SQL servers, Azure Active Directory servers, OpenLDAP servers, Oracle Databases, SalesForce applications, ServiceNow applications, SAP applications or Google GSuite.

Accordingly, the collectors 156 of the identity management system 150 may obtain or collect event data from various systems within the enterprise environment 100 and process the event data to associate the event data with the identities defined in the identity management data 154 to evaluate or analyze these events or other data in an identity management context. A user may interact with the identity management system 150 through a user interface 158 to access or manipulate data on identities, roles, entitlements, events or generally perform identity management with respect to enterprise environment 100.

The identity management system 160 may generate an identity graph to represent the identity management data obtained from the enterprise environment 100. In some embodiments, to generate such an identity graph, identity management system 160 may include a harvester 162 and a graph generator 164. The harvester 162 may obtain identity management data from one or more identity management systems 150 associated with enterprise 100. The identity management data may be obtained, for example, as part of a regular collection or harvesting process performed at some regular interval by connecting to, and requesting the identity management data from, the identity management system 150. The identity management data stored may thus include a set of entries, each entry corresponding to and including an identity as defined and managed by the identity management system, a list or vector of entitlements or roles assigned to that identity by the identity management system, and a time stamp at which the identity management data was collected from the identity management system 150. The identity management data may also include a set of entries for roles, each entry corresponding to and including a role as defined and managed by the identity management system 150 and a list or vector of entitlements assigned to that role by the identity management system 150, and a time stamp at which that identity management data was collected from the identity management system 150.

Graph generator 164 may generate an identity graph from the obtained identity management data. Formally, it may be understood that a graph is a data structure consisting of vertices and edges. The vertices are sometimes also referred to as nodes and the edges are lines or arcs that connect any two nodes in the graph. More formally a graph is composed of a set of vertices (V) and a set of edges (E). The graph is denoted by G(E, V). The relationship of links (or edges) between nodes is represented under a square matrix called adjacency matrix (denoted as A). Features of nodes are embedded in a graph signal features matrix (represented as X).

Specifically, in one embodiment, an identity graph may be generated from the identity management data obtained from the enterprise. Each of the identities and entitlements from the most recently obtained identity management data may be determined and a node of the graph created for each identity and entitlement. An edge is constructed between every pair of nodes (e.g., identities) that shares at least one entitlement and between every pair of nodes (e.g., entitlements) that shares at least one identity. Each edge of the graph may also be associated with a similarity weight representing a degree of similarity between the identities of the respective nodes joined by that edge, or between the entitlements of the respective nodes joined by that edge. It will be noted here that while a similarity weight may be utilized on edges between both identity nodes and entitlement nodes, the similarity weight type, determination and value may be determined differently based upon the respective type of node(s) being joined that weighted edge. Accordingly, the obtained identity management data may be represented by an identity graph (e.g., per enterprise) and stored in graph data store 166.

Once the identity graph is generated by the graph generator 164, the graph may then be pruned to remove edges based on their weighting. Again, the pruning of edges between identity nodes and entitlements nodes may be accomplished in the same, or a different manner. For example, a pruning threshold utilized to prune edges between identity nodes may be different than a pruning threshold utilized to prune edges between entitlement nodes as well as across customers.

As discussed, the identity management system 160 may provide a number of (identity management) components 174 that are adapted to perform certain tasks related to identity management functionality (e.g., generation, processing or analysis of identity management data) based on the generated identity graph (e.g. processing or analysis). In certain embodiments, these components 174 may include a clustering (e.g., peer grouping) component, a role mining or access modeling component, a role validation component, an access recommender component or an outlier and anomaly detection component, among others. Thus, the tasks for identity management components 174 may, for example, be related to node-level tasks, edge-level tasks, or graph-level tasks relative to the generated identity graph.

Examples of the functionality of such are described for example in U.S. Pat. No. 10,681,056, issued Jun. 9, 2020, entitled “System and Method for Outlier and Anomaly Detection in Identity Management Artificial Intelligence Systems Using Cluster Based Analysis of Network Identity Graphs”; U.S. Pat. No. 10,476,952, issued Nov. 12, 2019, entitled “System and Method for Peer Group Detection, Visualization and Analysis In Identity Management Artificial Intelligence Systems Using Cluster Based Analysis of Network Identity Graphs”; U.S. Pat. No. 11,122,050, issued Sep. 14, 2021, entitled “System and Method for Intelligent Agents for Decision Support in Network Identity Graph Based Identity Management Artificial Intelligence Systems”; U.S. Pat. No. 11,196,775, issued Dec. 7, 2021, entitled “System and Method for Predictive Modeling for Entitlement Diffusion and Role Evolution in Identity Management Artificial Intelligence Systems Using Network Identity Graphs”; U.S. Pat. No. 10,554,665 issued Feb. 4, 2020, entitled “System and Method for Role Mining In Identity Management Artificial Intelligence Systems Using Cluster Based Analysis of Network Identity Graphs”; U.S. Pat. No. 10,938,828, issued Mar. 2, 2021, entitled “System and Method for Predictive Platforms in Identity Management Artificial Intelligence Systems Using Analysis of Network Identity Graphs”; U.S. Pat. No. 10,862,928, issued Dec. 8, 2020, entitled “System and Method for Role Validation in Identity Management Artificial Intelligence Systems Using Analysis of Network Identity Graphs”, and U.S. Pat. No. 11,227,055, issued Jan. 18, 2022, entitled “System and Method for Automated Access Request Recommendations”; all of which are incorporated herein by reference in their entirety for all purposes.

Accordingly, each of components 174 may utilize an associated GNN adapted for the functionality of that component, where the graph neural network utilized by a particular component 174 is trained based on the generated identity graph stored in the graph data store 166. In particular, in certain embodiments, identity management system 160 includes graph neural network framework 172. Graph neural network framework 172 may include a graph trainer 178 and a set of loss functions 176. Each of the loss functions 176 may be designed for the implementation of a corresponding function to be implemented by an identity management component 174. Thus, graph neural network framework 172 may train a graph neural network for a particular component 174 based on the identity graph in graph data store 166 and the corresponding loss function 176 adapted for the task of that component 174. The component 174 can then be provisioned with the respective trained graph neural network 182 for that component 174 such that the component 174 can utilize that graph neural network 182 for performing its function.

An interface 168 of the identity management system 160 may present one or more interfaces that interact with the components 174 to allow access to the functionality of a component 174 and to present data (e.g., risk assessment data) from these identity management components 174. For example, an interface 168 may present a visual representation of the identity graph, the identities, entitlements, or the peer groups in the identity graph to a user of the identity management system 160 associated with enterprise 100 to assist in compliance or certification assessments or evaluation of the identities, entitlements or roles as currently used by the enterprise (e.g., as represented in identity management data 154 of identity management system 150).

Before moving on, it will be noted here that while identity management system 160 and identity management system 150 have been depicted separately for purposes of explanation and illustration, it will be apparent that the functionality of identity management systems 150, 160 may be combined into a single or a plurality of identity management system as is desired for a particular embodiment and the depiction and separation of the identity management systems and their respective functionality has been depicted separately solely for purposes of ease of depiction and description.

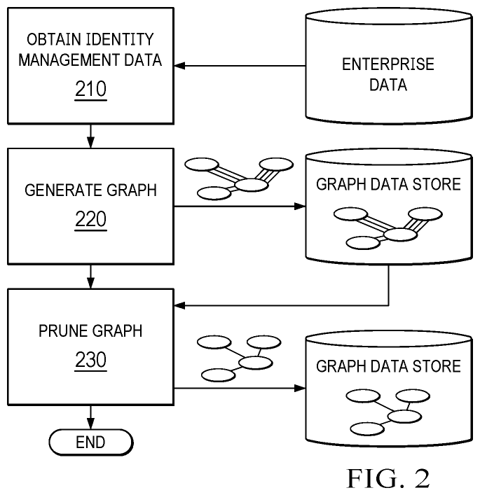

Turning now to FIG. 2, a flow diagram for one embodiment of a method for generating an identity graph is depicted. Embodiments of such a method may be employed by graph generators of identity management systems to generate identity graphs and associated peer groups from identity management data, as discussed above.

Initially, at step 210, identity management data may be obtained. As discussed, in one embodiment, this identity management data may be obtained from one or more identity management systems that are deployed in association with an enterprise's distributed computing environment. Thus, the identity management data may be obtained, for example, as part of a regular collection or harvesting process performed at some regular interval by connecting to, requesting the identity management data from, an identity management system. The identity management data may also be obtained on a one-time or user initiated basis.

As will be understood, the gathering of identity management data and determination of peer groups can be implemented on a regular, semi-regular or repeated basis, and thus may be implemented dynamically in time. Accordingly, as the data is obtained, it may be stored as a time-stamped snapshot. The identity management data stored may thus include a set of entries, each entry corresponding to and including an identity (e.g., alphanumerical identifiers for identities) as defined and managed by the identity management system, a list or vector of entitlements assigned to that identity by the identity management system, and a time stamp at which the identity management data was collected from the identity management system. The identity management data may also include data on roles or entitlements comprising those roles or identities that have been assigned those roles. Other data could also be associated with each identity, including data that may be provided from an identity management system such as a title, location or department associated with the identity. The collection of entries or identities associated with the same times stamp can thus be thought of as a snapshot from that time of the identities and entitlements of the enterprise computing environment as management by the identity management system.

As an example of identity management data that may be obtained from an identity management system, the following is one example of a JavaScript Object Notation (JSON) object that may relate to an identity:

```
{
  “attributes”: {
    “Department”: “Finance”,
    “costcenter”: “[R01e, L03]”,
    “displayName”: “Catherine Simmons”,
    “email”: “Catherine.Simmons@demoexample.com”,
    “empId”: “1b2c3d”,
    “firstname”: “Catherine”,
    “inactive”: “false”,
    “jobtitle”: “Treasury Analyst”,
    “lastname”: “Simmons”,
    “location”: “London”,
    “manager”: “Amanda.Ross”,
    “region”: “Europe”,
    “riskScore”: 528,
    “startDate”: “12/31/2016 00:00:00AM UTC”,
    “nativeIdentity_source_2”: “source_2”,
    “awesome_attribute_source_1”: “source_1”,
    “twin_attribute_a” : “twin a”,
    “twin_attribute_b” : “twin b”,
    “twin_attribute_c” : “twin c”
  },
  “id”: “2c9084ee5a8de328015a8de370100082”,
  “integration_id”: “iiq”,
  “customer_id”: “ida-bali”,
  “meta”: {
    “created”: “2017-03-02T07:19:37.233Z”,
    “modified”: “2017-03-02T07:24:12.024Z”
  },
  “name”: “Catherine.Simmons”,
  “refs”: {
    “accounts”: {
      “id”: [
        “2c9084ee5a8de328015a8de370110083”
      ],
      “type”: “account”
    },
    “entitlements”: {
      “id”: [
        “2c9084ee5a8de328015a8de449060e54”,
        “2c9084ee5a8de328015a8de449060e55”
      ],
      “type”: “entitlement”
    },
    “manager”: {
      “id”: [
        “2c9084ee5a8de022015a8de0c52b031d”
      ],
      “type”: “identity”
    }
  },
  “type”: “identity”
}
```

As another example of identity management data that may be obtained from an identity management system, the following is one example of a JSON object that may relate to an entitlement:

```
{
  “integration_id”: “bd992e37-bbe7-45ae-bbbf-c97a59194cbc”,
  “refs”: {
    “application”: {
      “id”: [
        “2c948083616ca13a01616ca1d4aa0301”
      ],
      “type”: “application”
    }
  },
  “meta”: {
    “created”: “2018-02-06T19:40:08.005Z”,
    “modified”: “2018-02-06T19:40:08.018Z”
  },
  “name”: “Domain Administrators”,
  “attributes”: {
    “description”: “Domain Administrators group on Active Directory”,
    “attribute”: “memberOf”,
    “aggregated”: true,
    “requestable”: true,
    “type”: “group”,
    “value”: “cn=Domain Administrators,dc=domain,dc=local”
  },
  “id”: “2c948083616ca13a01616ca1f1c50377”,
  “type”: “entitlement”,
  “customer_id”: “3a60b474-4f43-4523-83d1-eb0fd571828f”
}
```

As another example of identity management data that may be obtained from an identity management system, the following is one example of a JSON object that may relate to a role:

```
{
″id″: ″id″,
″name″: ″name″,
″description″:
″description″,
″modified″: ″2018-09-
07T17:49:33.667Z″, ″created″:
″2018-09-07T17:49:33.667Z″,
″enabled″: true,
″requestable″: true,
“tags”: [
{
      “id”: ″2c9084ee5a8ad545345345a8de370110083”
        “name” : “SOD-SOX”,
            “type”: ”TAG”
      },
{
      “id”: ″2c9084ee5a8ad545345345a8de370122093”
        “name” : “PrivilegedAccess”,
            “type”: ”TAG”
      },
]
″accessProfiles″:
[
  {
          ″id″: ″accessProfileId″,
    ″name″: ″accessProfileName″
}
],
″accessProfileCount″:
1, ″owner″: {
″name″: ″displayName″,
″id″: ″ownerId″
},
″synced″: ″2018-09-07T17:49:33.667Z″
}
```

At step 220 an identity graph may be generated from the identity management data obtained from the enterprise. Specifically, each of the identities and entitlements from the most recent snapshot of identity management data may be obtained and a node of the graph created for each identity and entitlement. An edge is constructed between every pair of identity nodes (e.g., identities) that shares at least one entitlement (e.g., an edge connects two identity nodes if and only if they have at least one entitlement in common). An edge may also be constructed between every pair of entitlement nodes (e.g., entitlements) that shares at least one identity (e.g., an edge connects two entitlement nodes if and only if they have at least one identity in common).

Each edge of the graph joining identity nodes, entitlement nodes or role nodes may be associated with a similarity weight representing a degree of similarity between the identities or entitlements of the respective nodes joined by that edge. For identity nodes, the similarity weight of an edge joining the two identity nodes may be generated based on the number of entitlements shared between the two joined nodes. As but one example, the similarity weight could be based on a count of the similarity (e.g., overlap or intersection of entitlements) between the two identities divided by the union of entitlements. Similarly, for identity nodes, the similarity weight of an edge joining the two entitlement nodes may be generated based on the number of identities shared between the two joined nodes. As but one example, the similarity weight could be based on a count of the similarity (e.g., overlap or intersection of identities) between the two entitlements divided by the union of identities. For instance, the similarity could be defined as the ratio between a number of identities having both entitlements joined by the edge to the number of identities that have either one (e.g., including both) of the two entitlements.

In one embodiment, the edges are weighted via a proper similarity function (e.g., Jaccard similarity). In one embodiment, a dissimilarity measure, of entitlement or identity binary vectors, d, may be chosen, then the induced similarity, 1−d(x,y), may be used to assign a similarity weight to the edge joining the nodes, x,y. Other methods for determining a similarity weight between two nodes are possible and are fully contemplated herein. Moreover, it will be noted here that while a similarity weight may be utilized on edges between both identity nodes and entitlement nodes, the similarity weight type, determination and value may be determined differently based upon the respective type of node(s) being joined that weighted edge.

In one specific, embodiment, a symmetric matrix for identities (e.g., an identity adjacency matrix) may be determined with each of the identities along each axis of the matrix. The diagonal of the matrix may be all 0s while the rest of values are the similarity weights determined between the two (identity) nodes on the axes corresponding to the value. In this manner, this symmetric matrix may be provided to a graph constructor which translates the identities on the axes and the similarity values of the matrix into graph store commands to construct the identity graph. Similarly, a symmetric matrix for entitlements (e.g., an entitlement adjacency matrix) may be determined with each of the entitlements along each axis of the matrix. The diagonal of the matrix may be all 0s while the rest of values are the similarity weights determined between the two (entitlement) nodes on the axes corresponding to the value. In this manner, this symmetric matrix may be provided to a graph constructor which translates the entitlement on the axes and the similarity values of the matrix into graph store commands to construct the identity graph.

Accordingly, the identity management data may be faithfully represented by a graph, with k types of entities (nodes/vertices, e.g., identity-id, title, location, entitlement, etc.) and stored in a graph data store. It will be noted that graph data store may be stored in any suitable format and according to any suitable storage, including, for example, a graph store such a Neo4j, a triple store, a relational database, etc. Access and queries to this graph data store may thus be accomplished using an associated access or query language (e.g., such as Cypher in the case where the Neo4j graph store is utilized).

Once the identity graph is generated, the graph may then be pruned at step 230. Here, the identity graph may be pruned to remove weak edges (e.g., those edges whose similarity weight may fall below a pruning threshold). The pruning of the graph is associated with the locality aspect of identity governance, where an identity's access entitlements should not be directly impacted, if at all, by another identity with strongly dissimilar entitlement pattern (e.g., a weak connecting edge) or that determined should be based on strong commonality or popularity of entitlements within an identity grouping. Accordingly, the removal of such edges may not dramatically alter the global topology of the identity graph. An initial pruning threshold may be initially set or determined (e.g., as 50% similarity or the like) and may be substantially optimized or otherwise adjusted at a later point. As another example, a histogram of similarity weights may be constructed and a similarity weight corresponding to a gap in the similarity weights of the histogram may be chosen as an initial pruning threshold. Again, the pruning of edges between identity nodes and entitlements nodes may be accomplished in the same, or a different manner. For example, the pruning threshold utilized to prune edges between identity nodes may be different than a pruning threshold utilized to prune edges between entitlement nodes.

Embodiments of the identity management systems as disclosed may thus create, maintain or utilize identity graphs. These identity graphs may include a graph comprised of nodes and edges, where the nodes may include identity management nodes representing, for example, an identity, entitlement, role, or other identity management artifact, and the edges may include relationships between these identity management nodes. The relationships represented by the edges of the identity graph may be assigned weights or scores indicating a degree of similarity between the nodes related by a relationship, including, for example, the similarity between two nodes representing an identity or two nodes representing an entitlement, as discussed. Additionally, the relationships may be directional, such that they may be traversed only in a single direction, or have different weightings depending on the direction in which the relationship is traversed or the nodes related. Embodiments of such an identity graph can thus be searched (or navigated) to determine data associated with one or more nodes. Moreover, the similarity between, for example, the identities, roles, or entitlements may be determined using the weights of the relationships in the identity graph.

Specifically, in certain embodiments, an identity graph may be thought of as a graph comprising a number of interrelated nodes. These nodes may include nodes that may have features defining the type of the node (e.g., the type of “thing” or entity that the node represents, such as an identity, entitlement, role, etc.) and properties that define the attributes or data of that node. For example, the features of the nodes of an identity graph may include “Identity”, “Entitlement” or “Role”. Properties (or features) of a node may include, “id”, “company”, “dept”, “title”, “location”, “source” “size”, “clique”, “mean_similarity”, or the like.

The nodes of the identity graph may be interrelated using relationships that form the edges of the graph. A relationship may connect two nodes in a directional manner. These relationships may also have a label that defines the type of relationship and properties (features) that define the attributes or data of that relationship. These properties may include an identification of the nodes related by the relationship, an identification of the directionality of the relationship or a weight or degree of affinity for the relationship between the two nodes. For example, the labels of the relationships of an identity graph may include “Similarity” or “SIM”, “Has_Entitlement” or “HAS_ENT”, “PART_OF”, or the like.

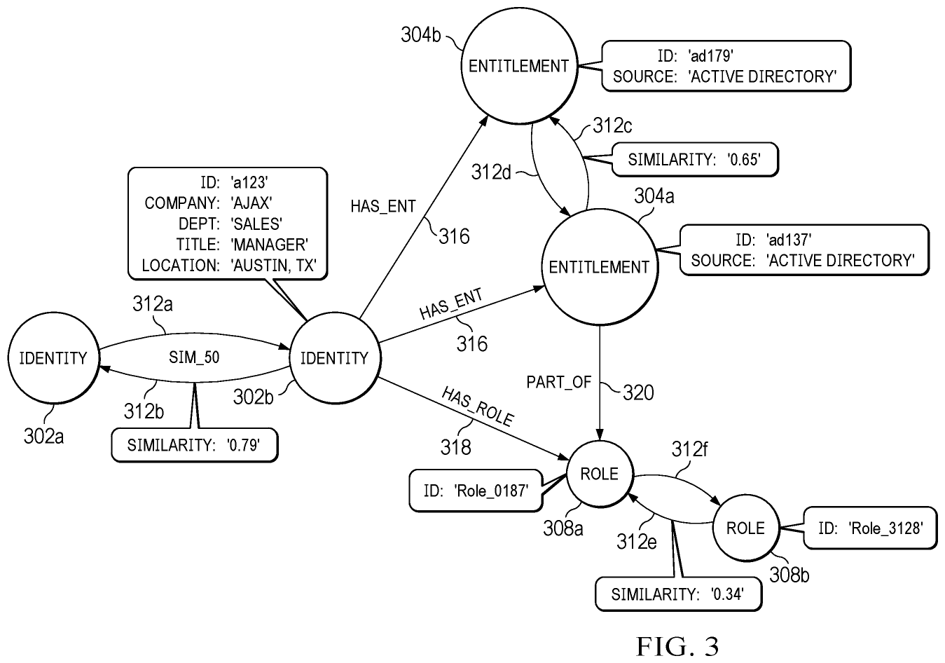

Referring then to FIG. 3, a graphical depiction of a portion of an example identity graph 300 is depicted. Here, nodes are represented by circles and relationships are represented by the directional arrows between the nodes. Such an identity graph 300 may represent identities, entitlements or roles, their association, and the degree of similarity between identities or roles represented by the nodes. Thus, for example, the identity nodes 302a, 302b have the label “Identity” indicating they are identity nodes. Identity node 302b is shown as being associated with a set of properties that define the attributes or data of that identity node 302b, including here that the “id” of identity node 302b is “a123”, the “company” of identity node 302b is “Ajax”, the “dept” of identity node 302b is “Sales”, the “title” of identity node 302b is “Manager”, and the “location” of identity node 302b is “Austin, TX”.

These identity nodes 302 of the identity graph 300 are joined by edges formed by directed relationships 312a, 312b. Directed relationship 312a may represent that the identity of identity node 302a is similar to (represented by the labeled “SIM” relationship 312a) the identity represented by identity node 302b. Similarly, directed relationship 312b may represent that the identity of identity node 302b is similar to (represented by the labeled “SIM” relationship 312b) the identity represented by identity node 302a. Here, relationship 312b has been assigned a similarity weight of 0.79. Notice that while these relationships 312a, 312b are depicted as individual directional relationships, such a similar relationship may be a single bidirectional relationship assigned a single similarity weight.

Entitlement nodes 304a, 304b have the label “Entitlement” indicating that they are entitlement nodes. Entitlement node 304a is shown as being associated with a set of properties that define the attributes or data of that entitlement node 304a, including here that the “id” of entitlement node 304 is “ad137”, and the “source” of entitlement node 304a is “Active Directory”. Entitlement node 304b is shown as being associated with a set of properties that define the attributes or data of that entitlement node 304b, including here that the “id” of entitlement node 304b is “ad179”, and the “source” of entitlement node 304b is “Active Directory”.

These entitlement nodes 304 of the identity graph 300 are joined by edges formed by directed relationships 312c, 312d. Directed relationship 312c may represent that the entitlement node 304a is similar to (represented by the labeled “SIM” relationship 312c) the entitlement represented by entitlement node 304b. Similarly, directed relationship 312d may represent that the entitlement of entitlement node 304b is similar to (represented by the labeled “SIM” relationship 312d) the entitlement represented by entitlement node 304a. Here, relationship 312c has been assigned a similarity weight of 0.65. Notice that while these relationships 312c, 312d are depicted as individual directional relationships, such a similar relationship may be a single bidirectional relationship assigned a single similarity weight.

Identity node 302b and entitlement nodes 304a, 304b of the identity graph 300 are joined by edges formed by directed relationships 316. Directed relationships 316 may represent that the identity of identity node 302b has (represented by the labeled “HAS_ENT” relationships 316) the entitlements represented by entitlement nodes 304a, 304b.

Role nodes 308a, 308b have the label “Role” indicating that they are Role nodes. Role node 308a is shown as being associated with a set of properties that define the attributes or data of that Role node 308a, including here that the “id” of entitlement node 308a is “Role_0187”. Role node 308b is shown as being associated with a set of properties that define the attributes or data of that role node 308b, including here that the “id” of role node 308b is “Role_3128”. Directed relationship 318 may represent that the identity of identity node 302b has (represented by the labeled “HAS_ROLE” relationship 318) the role represented by role node 308a. Directed relationship 320 may represent that the entitlement of entitlement node 304a is a part of or included in (represented by the labeled “PART_OF” relationship 320) the role represented by role node 308a.

These role nodes 308 of the identity graph 300 are joined by edges formed by directed relationships 312e, 312f. Directed relationship 312e may represent that the role represented by role node 304a is similar to the role represented by role node 304b. Similarly, directed relationship 312f may represent that the role represented by role node 308b is similar to the role represented by role node 308a. Here, relationship 312e has been assigned a similarity weight of 0.34. Again, notice that while these relationships 312e, 312f are depicted as individual directional relationships, such a similar relationship may be a single bidirectional relationship assigned a single similarity weight.

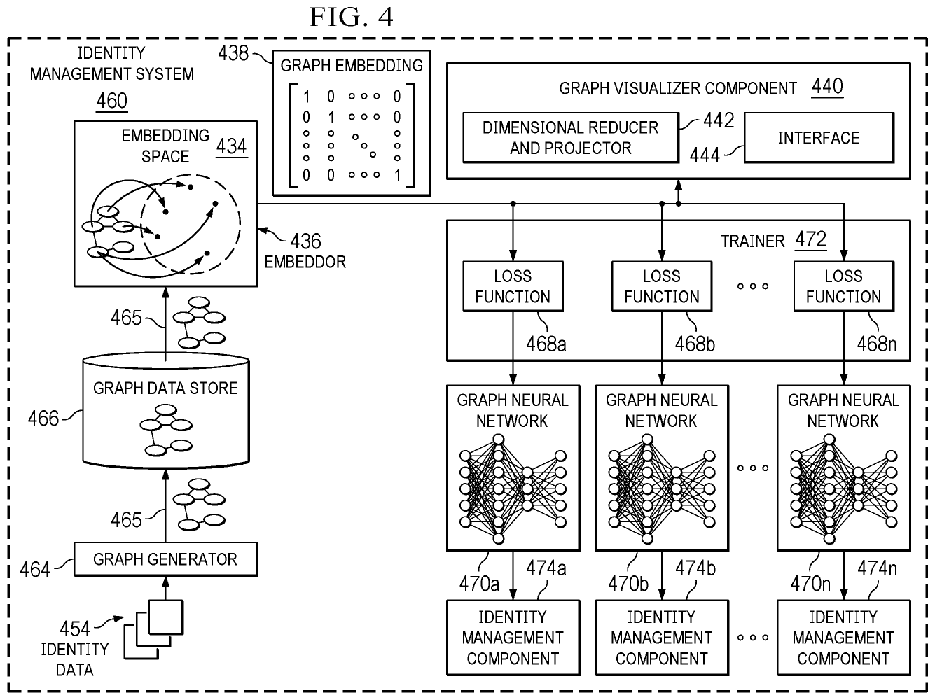

With embodiments of such an identity graph in mind, attention is now directed to FIG. 4 where one embodiment of the use of a graph neural network framework for implementing identity management components in an identity management system 460 is depicted. As discussed, the identity management system 460 may obtain identity management data 454 and generate an identity graph 465 from the identity management date 454 using graph generator 464. This identity management graph 465 can be stored in graph data store 466.

At some interval, the identity graph 465 may be provided to embeddor 436. Embeddor 436 may generate a graph embedding 438 by embedding the identity graph 465 in an embedding space 434. The relationship of links (or edges) between nodes is represented under an adjacency matrix (denoted as A, where AϵR^{N×N}), which defines the topological features of the identity graph 465. Features of nodes (like features for identity management) are embedded in a graph signal features matrix (represented as X, where XϵR^{N×F}). To generate the embedding 438 embeddor 436 may function as an aggregator, using message passing or the like.

According to embodiments then, a node in the graph computes a message for each of its neighbors. Messages are a function of the node, the neighbor, and the edge between them. (the function is usually a multi-layer perceptron). Messages are sent, and every node aggregates the messages it receives, using a permutation-invariant function (i.e., the function is agnostic to the order in which messages are received). This function is usually a sum or an average, but may be otherwise. After receiving the messages, each node updates its attributes as a function of its current attributes and the aggregated messages.

Once the embedding 438 is generated, trainer 472 may train a graph neural network (e.g., 470a, 470b, 470n) for a corresponding identity management component (e.g., 474a, 474b, 474n) using a loss function (e.g., 468a, 468b, 468n) designed for the functionality of that component 474. Specifically, the embedding 438 of the identity graph 465 may be trained based on the corresponding loss function 468 for that component 474 to yield the graph neural network 470 for the component 474. The component 474 can then be provisioned with the respective trained graph neural network 470 for that component 474 such that the component 174 can utilize that graph neural network for performing it's function. Specifically, the component 474 can be adapted to utilize the respective graph neural network 470 trained based on the associated loss function to generate a first identity management signal using the first graph neural network.

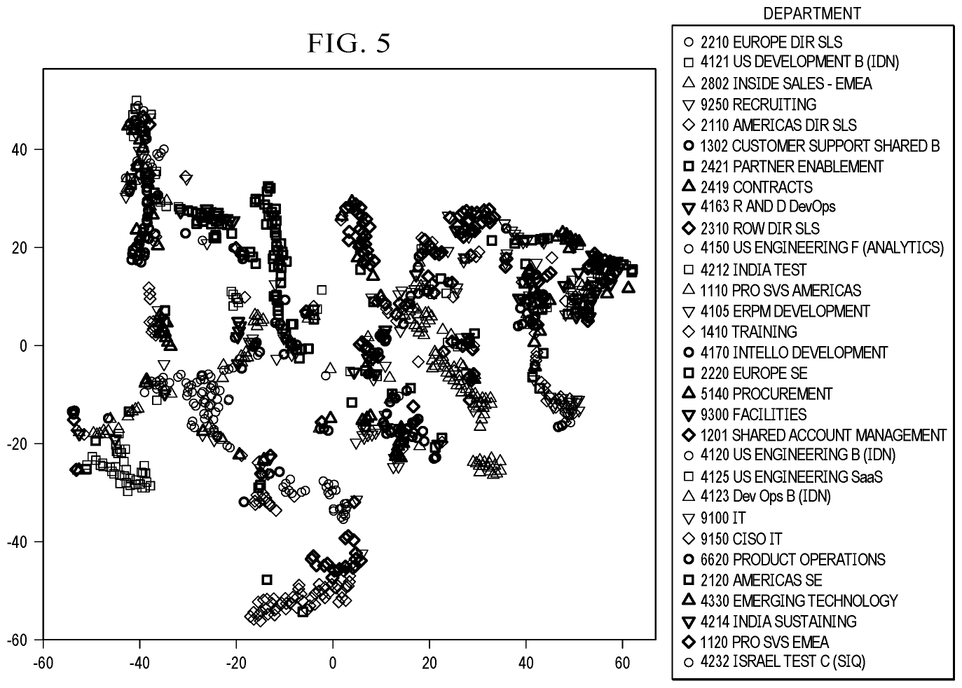

Additionally, identity management system 460 may include a graph visualizer component 440 that may provide a visualization of the identity graph 465 through interface 444 based on the embedding 438 generated from that identity graph. Specifically, the graph visualizer 440 may include a dimensional reducer and projector 442. The dimensional reducer and projector 442 utilizes the graph embedding 438 representing the identity graph 465 generated during the training of graph neural networks 470 (including node and edge attributes of the identity graph 465) to generate lower dimensional embedding (e.g. 200 dimensions or the like) of the graph 465. By combining the graph neural network embedding 438 with proper dimension reduction techniques (e.g. t-distributed stochastic neighbor embedding (tSNE) or PHate), the graph visualizer 440 may project the resulting reduced embeddings in two or three dimensions for the user to be presented with a visualization of identity graph 465 through interface 444. FIG. 5 depicts an embodiments of such a graph visualization.

It may be useful to illustrate the training of a graph neural network and application of a graph neural network for an identity management component for a particular use case. As discussed above, clusters or communities are a property of many graph networks in which a particular network may have multiple communities comprising network nodes that are tightly connected in knit groups within communities and loosely connected between communities. Community detection, also called graph partitioning or graph clustering, may be utilized to reveal relations among the nodes in the identity graph. The identified clusters can be utilized to perform a variety of identity management tasks. For example, clustering of highly similar nodes in an identity graph (e.g., nodes representing identities, entitlements, roles) may help with effective identity management

Thus, as part of a robust identity management system, it may be desirable to group or cluster the identities, roles or entitlements of an enterprise into peer groups such that, for example, the identities in a peer group are similar with respect to the set of entitlements assigned to the identities of that group (e.g., relative to other identities or other groups) or, to determine peer groups of entitlements such that entitlement patterns and assignment may be determined and role mining performed.

Peer grouping of the identities within an enterprise (or viewing the peer groups of identities) may allow, for example, an auditor other person performing a compliance analysis or evaluation to quantitatively or qualitatively assess the effectiveness of any applicable pre-existing polices, or lack thereof, and how strictly they are enforced. Similarly, peer grouping of entitlements may allow roles to be determined from such entitlement groups and outlier entitlements to be identified. This information may, in turn, be utilized to redefine or govern existing roles as defined in the identity management system and allow users of the identity management system greater visibility into the roles of the enterprise.

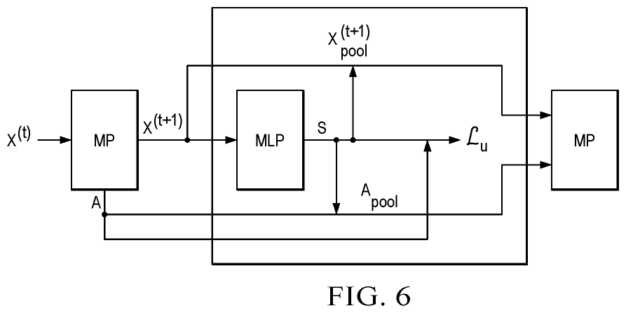

Accordingly, identity management components may utilize a graph neural network to perform clustering tasks within an identity management system. FIG. 6 is a depiction of one embodiment of the training of a graph neural network for a task for a component and will be described with respect to the training of a graph for clustering of an identity graph as described. Recall that the relationship of links (or edges) between nodes in the identity graph is represented under a square matrix called adjacency matrix (denoted as A, where AϵR^{N×N}), which defines the topological features of the identity graph while features of nodes (like features for identity management) are embedded in a graph signal features matrix (represented as X, where XϵR^{N×F}). These matrices may include, for example, an identity information matrix with rows being each unique employee ids and columns being their attributes, job-title, department, etc., and entitlement information matrix with rows being each entitlement ids and columns being their attributes, name of entitlement, source, usage, etc.

The node feature matrix X and structure of graph matrix A pass through message passing paradigm to obtain an embedding representation and then passing through a multilayer perceptron plus softmax activation(with the number of hidden units to be k—predefined number of expected max clusters) to obtain the soft clustering matrix S. Pool feature and adjacency matrix can be derived by multiplying with S. To obtain the partition, the argmax of S may be found—the cluster that has the highest probability for each node.

In certain embodiments, such an optimization process relies on a global measurement where a mincut may be a minimum cut or min-cut of a graph is a cut (a partition of the vertices of a graph into two disjoint subsets) that is minimal in some metric. In this case, the metric is the overall intra-cluster edge weight. Additionally, modularity may quantify the quality of an assignment of nodes to communities (e.g., to a cluster) by evaluating how much more densely connected the nodes within a community are, compared to how connected they would be in a random graph (particularly a configuration model). Thus, a loss function used to train such a graph neural network for clustering may be, for example, spectral loss version of modularity.

Those skilled in the relevant art will appreciate that the invention can be implemented or practiced with other computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods or programs of embodiments of the invention described herein, including R, Python, C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

What is claimed is:

1. An identity management system, comprising:
a data store;
a processor;
a non-transitory, computer-readable storage medium, including computer instructions for:
obtaining identity management data from one or more source systems in a distributed enterprise computing environment of an enterprise, the identity management data comprising data on a set of identities, a set of entitlements, or a set of roles, wherein the set of identities, set of entitlements or set of roles are utilized in identity management in the distributed enterprise computing environment;
generating a first identity graph from the identity management data at a first time;
training a first graph neural network for a first identity management component; and
adapting the first identity management component to use the first graph neural network such that the first identity management component is adapted to generate a first identity management signal using the first graph neural network.

2. The system of claim 1, wherein training the first graph neural network comprises:
generating a first embedding from the first graph neural network; and
training the first graph neural network based on the first embedding and a first loss function associated with the first identity management component.

3. The system of claim 2, wherein the first identity management signal is associated with clustering of the identity graph.

4. The system of claim 3, wherein the first loss function is a spectral loss version of modularity.

5. The system of claim 2, comprising:
training a second graph neural network based on the embedding and a second loss function associated with a second identity management component; and
adapting the second identity management component to generate a second identity management signal using the second graph neural network.

6. The system of claim 5, comprising:
updating the identity management data;
generating a second identity graph from the updated identity management data at a second time;
training a second graph neural network for the first identity management component; and
adapting the first identity management component to use the second graph neural network such that the first identity management component is adapted to generate the first identity management signal using the second graph neural network.

7. The system of claim 6, wherein training the second graph neural network comprises:
generating a second embedding from the second graph neural network; and
training the second graph neural network based on the second embedding and the first loss function associated with the first identity management component.

8. A method for identity management, comprising:
obtaining identity management data from one or more source systems in a distributed enterprise computing environment of an enterprise, the identity management data comprising data on a set of identities, a set of entitlements, or a set of roles, wherein the set of identities, set of entitlements or set of roles are utilized in identity management in the distributed enterprise computing environment;
generating a first identity graph from the identity management data at a first time;
training a first graph neural network for a first identity management component; and
adapting the first identity management component to use the first graph neural network such that the first identity management component is adapted to generate a first identity management signal using the first graph neural network.

9. The method of claim 8, wherein training the first graph neural network comprises:
generating a first embedding from the first graph neural network; and
training the first graph neural network based on the first embedding and a first loss function associated with the first identity management component.

10. The method of claim 9, wherein the first identity management signal is associated with clustering of the identity graph.

11. The method of claim 10, wherein the first loss function is a spectral loss version of modularity.

12. The method of claim 9, further comprising:
training a second graph neural network based on the embedding and a second loss function associated with a second identity management component; and
adapting the second identity management component to generate a second identity management signal using the second graph neural network.

13. The method of claim 12, further comprising:
updating the identity management data;
generating a second identity graph from the updated identity management data at a second time;
training a second graph neural network for the first identity management component; and
adapting the first identity management component to use the second graph neural network such that the first identity management component is adapted to generate the first identity management signal using the second graph neural network.

14. The method of claim 13, wherein training the second graph neural network comprises:
generating a second embedding from the second graph neural network; and
training the second graph neural network based on the second embedding and the first loss function associated with the first identity management component.

15. A non-transitory computer readable medium, comprising instructions for:
obtaining identity management data from one or more source systems in a distributed enterprise computing environment of an enterprise, the identity management data comprising data on a set of identities, a set of entitlements, or a set of roles, wherein the set of identities, set of entitlements or set of roles are utilized in identity management in the distributed enterprise computing environment;
generating a first identity graph from the identity management data at a first time;
training a first graph neural network for a first identity management component; and
adapting the first identity management component to use the first graph neural network such that the first identity management component is adapted to generate a first identity management signal using the first graph neural network.

16. The non-transitory computer readable medium of claim 15, wherein training the first graph neural network comprises:
generating a first embedding from the first graph neural network; and
training the first graph neural network based on the first embedding and a first loss function associated with the first identity management component.

17. The non-transitory computer readable medium of claim 16, wherein the first identity management signal is associated with clustering of the identity graph.

18. The non-transitory computer readable medium of claim 17, wherein the first loss function is a spectral loss version of modularity.

19. The non-transitory computer readable medium of claim 16, further comprising instructions for:
training a second graph neural network based on the embedding and a second loss function associated with a second identity management component; and
adapting the second identity management component to generate a second identity management signal using the second graph neural network.

20. The non-transitory computer readable medium of claim 19, further comprising instructions for:
updating the identity management data;
generating a second identity graph from the updated identity management data at a second time;
training a second graph neural network for the first identity management component; and
adapting the first identity management component to use the second graph neural network such that the first identity management component is adapted to generate the first identity management signal using the second graph neural network.

21. The non-transitory computer readable medium of claim 20, wherein training the second graph neural network comprises:
generating a second embedding from the second graph neural network; and
training the second graph neural network based on the second embedding and the first loss function associated with the first identity management component.
